(19) United States
(12) Patent Application Publication
(10) Pub. No.: US 2006/0283996 A1
(43) Pub. Date: Dec. 21, 2006

(54) Reinforced absorbent article

(75) Inventor: Ronald Jensen, Moraga, CA (US)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: Paper Pak Industries-PPI

(21) Appl. No.: 11/446,797

(22) Filed: Jun. 5, 2006

Related U.S. Application Data
(60) Provisional application No. 60/687,724, filed on Jun. 6, 2005.

(51) Int. Cl. B02C 13/00

(52) U.S. Cl. 241/195

(57) ABSTRACT

The present invention provides a reinforced absorbent article that includes one or more reinforcement means. The reinforced absorbent article allows for the use of high-speed processing without machinery malfunction and downtime. In one embodiment the reinforced absorbent article is a reinforced absorbent food pad.

### CROSS-REFERENCE TO A RELATED APPLICATION

The present application claims priority to pending U.S. Provisional Patent Application No. 60/687,724, filed Jun. 6, 2005, which is incorporated by reference herein in its entirety.

### BACKGROUND OF THE INVENTION

1. Field of Invention

The present invention relates generally to an absorbent article. More particularly, the present invention relates to a reinforced absorbent article.

2. Description of Related Art

Absorbent articles, such as absorbent pads, are used in a variety of applications where liquid or fluid absorption is desirable. Such applications include, but are not limited to, food packaging, medical, environmental, industrial, and the like.

For example, absorbent food pads are frequently inserted into a tray or other type of container. The insertion of the pads is typically carried out using an automated, mechanical process. One particular problem with the mechanical process, due primarily to the pliability and/or flexibility of an absorbent pad, is that a pad or sheet of pads can become disoriented on the machinery, causing machine malfunction and downtime. As a result, the process machinery is typically operated at slower speeds to compensate for the pliable and/or flexible characteristics of the pad material.

Therefore, a strong need exists in the art for a reinforced absorbent article that allows for high-speed processing without process machinery malfunction and downtime. The present invention meets this need.

### SUMMARY OF THE INVENTION

It is an object of the present invention to provide a reinforced absorbent article with one or more reinforcement means.

It is another object of the present invention to provide such a reinforced absorbent article where the reinforcement means include one or more stiffening ribs.

It is yet another object of the present invention to provide such a reinforced absorbent article that allows for high-speed processing.

It is a further object of the present invention to provide such a reinforced absorbent article that is a reinforced absorbent food pad.

It is still a further object of the present invention to provide a process for forming such a reinforced absorbent article.

These and other objects and advantages of the present invention are provided by a reinforced absorbent article. The reinforced absorbent article includes one or more reinforcement means. As a result, the reinforced absorbent article allows for the use of high-speed processing without machinery malfunction and downtime. In one preferred embodiment, the reinforced absorbent article is a reinforced absorbent food pad.

### BRIEF DESCRIPTION OF DRAWINGS

FIG. 1 is a top view of a prior art absorbent pad;

FIG. 2 is a cut away view of the prior art absorbent pad of FIG. 1 taken along line A-A;

FIG. 3 is a top view of a reinforced absorbent pad according to the present invention;

FIG. 4 is a cut away view of the reinforced absorbent pad of FIG. 3 taken along line B-B, according to the present invention;

FIG. 5 is a top view of another reinforced absorbent pad according to the present invention; and

FIG. 6 is a cut away view of the reinforced absorbent pad of FIG. 5 taken along line C-C, according to the present invention;

### DETAILED DESCRIPTION OF THE INVENTION

The present invention provides a reinforced absorbent article with one or more reinforcement means. The one or more reinforcement means allows for the use of high-speed process machinery during manufacture of the absorbent article. As a result, the reinforced absorbent article can be manufactured more efficiently than an article without such reinforcement means. The reinforced absorbent articles of the present invention may be used in a variety of applications where liquid or fluid absorption is desirable. Such applications include, but are not limited to, food packaging, medical, environmental, industrial cleaning, residential cleaning, and the like.

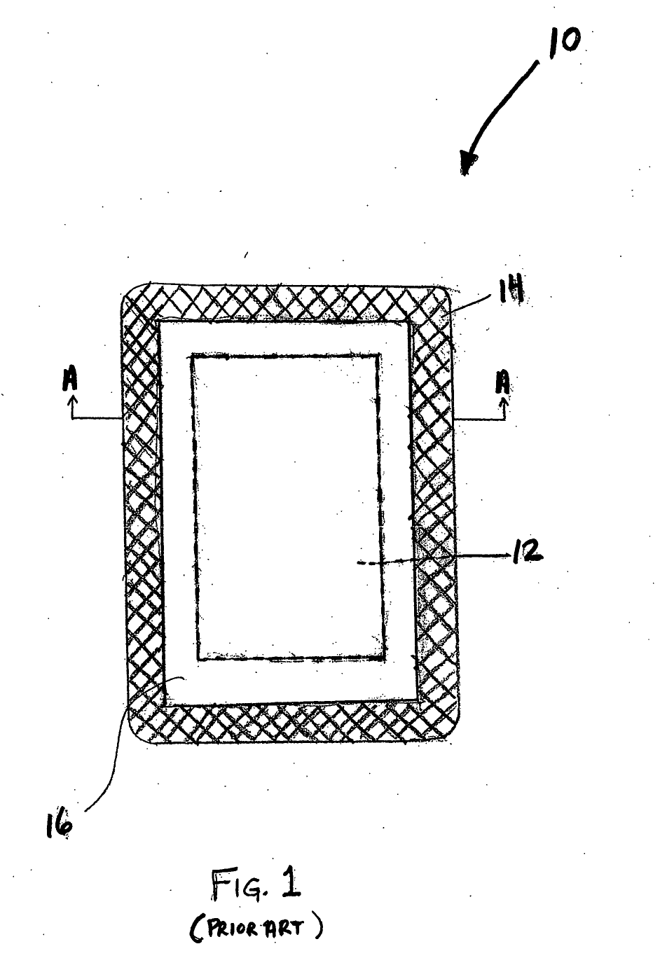

Referring to FIG. 1, a top view of a prior art absorbent article in the form of a pad is represented generally by reference numeral 10. Absorbent pad 10 has an absorbent core or layer(s) 12 disposed between one or more top sheets 16 and bottom sheets (not shown). The one or more top sheets 16 and bottom sheets are typically sealed around the periphery 14.

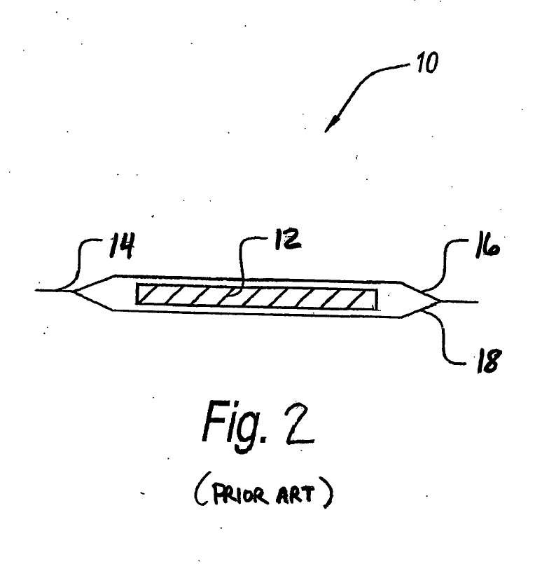

Referring to FIG. 2, a cut away view of absorbent pad 10 is depicted. Absorbent pad 10 has a top sheet 16 and a bottom sheet 18 separated by an absorbent core/layer(s) 12. The top and bottom sheets are the outer layers of absorbent pad 10 and are typically composed of film, non-woven fabric, or paper. The top and bottom sheets are typically bonded together around a periphery 14 of absorbent pad 10.

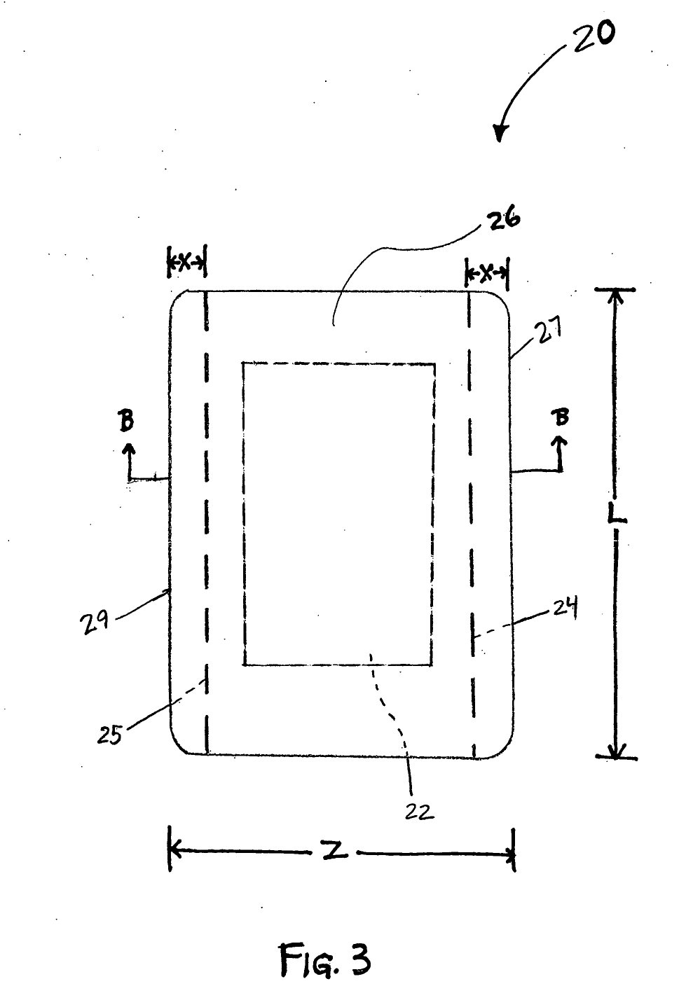

Referring to FIG. 3, a top view of a reinforced absorbent pad according to the present invention is represented generally by reference numeral 20. Reinforced absorbent pad 20 has an absorbent core or layer(s) 22 disposed between one or more top sheets 26 and one or more bottom sheets (not shown). A novel aspect of the reinforced absorbent pad of the present invention is the inclusion of one or more reinforcement means 24, 25.

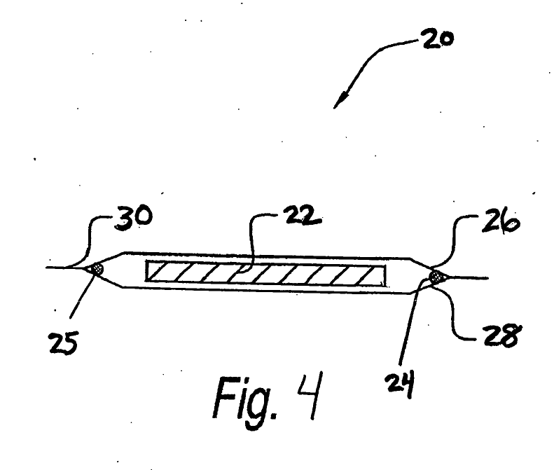

Referring to FIG. 4, a cut away view of reinforced absorbent pad 20 is depicted. Reinforced absorbent pad 20 has one or more top sheets 26 and one or more bottom sheets 28 separated by an absorbent core/layer(s) 22. The top and bottom sheets form the outer layers of reinforced absorbent pad 20 and are typically composed of one or more layers of film, non-woven fabric, paper, or any combinations thereof. The top and bottom sheets, for example, are bonded together around a periphery 30 of absorbent pad 20. One or more reinforcement means 24, 25 are disposed between the one or more top and bottom layers of reinforced absorbent pad 20.

The one or more reinforcement means may include any suitable structure, geometry and/or material that imparts a desired stiffness and/or rigidity to the absorbent structure. Suitable geometry includes, but is not limited to, circular, elliptical, square, rectangular, polygonal, triangular, or any combinations thereof.

Suitable material for the one or more reinforcement means includes, but is not limited to, plastic, rubber, wood, metal, fiberglass, composites, paper, compressed paper, paper board, fiber board, cork, or any combinations thereof. If the desired reinforced absorbent article is a reinforced absorbent food pad or medical pad, any suitable reinforcement means made from and/or including food grade and/or FDA approved material may be used in the present invention.

Suitable structure for the one or more reinforcement means includes, but is not limited to, one or more strips, ribs, rods, ribbons, or any combinations thereof, of any suitable dimension that imparts the desired stiffness and/or rigidity to the absorbent structure.

Referring to FIG. 3, the one or more reinforcement means may have any suitable length L to achieve the desired stiffness and/or rigidity. Suitable length L includes, but is not limited to, between about 10% to about 100% of the total length of the absorbent article 20. Preferably, length L is between about 50% to about 100% and more preferably about 100% of the total length of absorbent article 20.

The one or more reinforcement means may be positioned in or on absorbent structure 20 at any distance X from a longitudinal edge 27, 29 that achieves the desired stiffness and/or rigidity. Suitable distance X includes, but is not limited to, between about 5% to about 35% of the total width Z of the absorbent article. Preferable, distance X is between about 15% to about 25% and more preferably about 20% of the total width Z of the absorbent article.

The one or more reinforcement means may have any suitable width that achieves the desired stiffness and/or rigidity. Suitable width may include, but is not limited to, between about 0.005 inches to about 0.5 inches. Preferably, the width is between about 0.025 inches and 0.25 inches. More preferably, the width is between about 0.06 inches and 0.09 inches.

The one or more reinforcement means may have any suitable thickness that achieves the desired stiffness and/or rigidity. Suitable thickness includes, but is not limited to, between about 0.001 inches and 0.1 inches. Preferably, the thickness is between about 0.005 inches and 0.05 inches and more preferably between about 0.01 inches and 0.03 inches.

The one or more reinforcement means may or may not be adhered or bonded to any one or more layers of material or components that make up the reinforced absorbent article of the present invention. When adhesion and/or bonding is desired, the one or more reinforcement means may be coated with adhesive prior to or during the manufacture of the reinforced absorbent article. Moreover, non-adhesive means, such as heat sealing or static charge may be used to secure the one or more reinforcement means to any other component of the reinforced absorbent article of the present invention. It is also contemplated that the one or more reinforcement means may be simply positioned in the reinforced absorbent article without addition of any adhesive or bonding.

The one or more top sheets 26 can be micro-perforated or slit. The one or more bottom sheets 28 can also be micro-perforated or slit. Either layer can be liquid impervious. Examples of appropriate films to be used for the one or more top and/or bottom sheets include, but are not limited to, polyethylene, polypropylene, polyester, or any combinations thereof.

Multiple materials can be used in either or both of the top sheet and bottom sheet of the reinforced absorbent article. These multiple materials can be simply adjacent to each other and not bonded except in areas that are heat-sealed. They can also be adhered without adhesive lamination using static attraction and/or corona discharge. The multiple materials may be point bonded, pattern bonded, or intermittently bonded to each other using an about 5% to about 20% bond area to provide attachment but easy separation. Using point bonding and attachment of the multiple layers can provide that the bonding pattern perforates through the outer impermeable film to form a hole having the perimeter of the hole fused between outer and inner materials within the layer. This fusion of the perimeter of the hole provides strength, wicking, and added containment of the absorbent core. Point bonding, using an about 5% to about 20% bond area, of adjacent materials in the layer in a controlled manner allows for certain bonding areas with full penetration through the materials of the layer while providing simple mechanical attachment in other areas of the layer.

The top sheet and/or bottom sheet of the reinforced absorbent article of the present invention can utilize between two and seven materials or layers. However, use of a single material is also possible. A preferred material is a co-extruded film of between two and seven material layers. Generally, the interior layer of the multiple layers used is a heat-sealing layer, such as a low-melt polymer layer. The outer layers can be of any thickness. Each outer layer is preferably between about 0.00075 inches and 0.003 inches in thickness. While white is a preferred color, the outer layers can be natural or pigmented in any color, and printing is possible on either surface.

The absorbent core material can be any material suitable for absorbing liquids, particularly food-product liquids. Examples of suitable absorbent materials include, but are not limited to, superabsorbent polymer (SAP), compressed SAP composite of superabsorbent polymer granules adhered with one or more binders and/or plasticizers, compressed composite containing a percentage of short or microfiber materials, thermoplastic polymer fibers, thermoplastic polymer granules, cellulose powders, cellulose gels, an airlaid with superabsorbent, any fibrous or foam structure that has been coated or impregnated with a superabsorbent, absorbent structure having one or more starch or cellulose based absorbents, absorbent structure containing superabsorbent material formed and/or crosslinked in situ, or any combinations thereof. Superabsorbent material can be used in various forms. Examples of suitable superabsorbent material forms include, but are not limited to, granular, fiber, liquid, superabsorbent hot melts, or any combinations thereof. Compressed composites of short and microfiber (from about 0.1 inches to about 0.3 inches in length) materials having between about 3% and about 25% short-fiber or micro-fiber content have been shown to strengthen the core for high speed processing but retain the desired properties of low cost and high speed absorption and wicking.

It has also been found that the reinforced absorbent article allows for the use of specific polymers that offer high elasticity and/or conformity in the outside layers. The use of such materials provides a reinforced absorbent article with increased ability to expand during the absorption of liquids. For example, high capacity, shaped reinforced absorbent pads that conform to specific packaging dimensions must typically expand in a vertical direction. The volume of the cavity or pocket formed by the upper and lower layers of the absorbent pad generally defines the degree of expansion. Conventional cast or blown films or spunbond non-wovens offer very little expansion. A polyurethane, metallocene polyethylene, and block copolymer (synthetic rubber), which can be cast or blown into a film or extruded into a non-woven (spunbond, meltblown, or any combinations thereof) either individually, as a co-extrusion or a bicomponent formation, or in a blend, have been found to provide increased expansion capability over conventional materials.

The top sheets and bottom sheets of the reinforced absorbent article of the present invention can be sealed together at the edges or periphery of the article or at various locations throughout the article. It has been found that to prevent seam failure that is prevalent in conventional absorbent articles, such as pads, due to the swelling of the absorbent core, proper sealing of the top sheet to the bottom sheet can be obtained through heat, pressure or ultrasonic sealing. These methods provide a solid bond capable of resisting bursting. An embossing, knurling, or point-bonding pattern can be used for even stronger and more flexible bonds than simple flat bonding.

Thermal sealing can provide a strong seam with a minimal amount of material from the top and bottom sheets. Using adhesives to bind the top sheet to the bottom sheet typically requires between about 0.25 inches to about 0.5 inches of material from the top and bottom sheets to create a sufficient seal. However, seals formed by this traditional method are prone to failure when the pad absorbs fluid and exerts stress on the seal. The methods of the present invention provide for strong sealing using only about 0.125 inches to about 0.5 inches of material to create the seams.

It has also been found that to further improve the heat sealing of film, non-woven, or paper layers it is possible for the film to be co-extruded, the non-woven to be bi-component, or the paper to be coated with a low-melt material. Generally, the low-melt materials, such as polymers, are on one side of the layer and are positioned toward the center of the pad. The low-melt materials can be on both layers to be sealed or on only one of the layers. It is preferred that both layers to be sealed have low-melt materials. A preferred co-extruded film is of a high-density polyethylene (HDPE) with an ethylene vinyl acetate (EVA) component on the low-melt side. A preferred thickness for these films is between about 0.0075 inches to about 0.003 inches. The layers can be corona treated to promote ink anchorage and seam bonding. Techniques for sealing the layers include conventional heat/pressure, thermal impulse sealing, radiant surface heat followed by pressure or heat/pressure, ultrasonic sealing, or any combinations thereof. An example of a combination of techniques is ultrasonic sealing preceded by thermal or radiant heat application.

It is possible to register or print the low-melt bond promoter or an adhesive at any point in the reinforced absorbent article in any shape or configuration. A rotary or intermittent printing process of any type could be used to achieve this outcome. In high-speed processes, a conventional gravure/doctor blade system was shown effective. For low-melt films or materials, a roll coat/Flexo print device is preferred, although a screen print process is also suitable. Using this device, coatings are generally between about 0.00075 inches to about 0.010 inches in thickness. Some adhesives suitable for use in this printing system include warm and hot melt adhesives, single component (reactive) moisture cure hot melts or liquids, and Ultraviolet (UV) cure hot melts or liquids.

One or more of the outer layers of each reinforced absorbent article of the present invention may be perforated to allow for fluid transport across the layer. One method of perforating the materials of the outer layers involves “cold needle” perforation at ambient temperatures. However, holes created with a “cold needle” technique lack a desired three dimensional characteristic that typically add rigidity to the layer, resist closure of the hole, and provide for easy entry but difficult exit of liquid from the absorbent article. Using either an ultrasonic pattern roll and anvil process or a hot-needle process to perforate the layers provides a thermally set hole that resists future movement or closure of the hole.

The reinforced absorbent articles of the present invention may also employ static charges to adhere various layers of the absorbent articles together. This improvement over the conventional use of glues and adhesives provides improved product safety via elimination of adhesive components, manufacturing advantages, cost reduction, and product improvement through stronger seal integrity. Using static electricity, typically involving emission of negative ions, the absorbent core material or other internal components can be adhered electrostatically to the top sheet, bottom sheet, or other layer of film, non-woven, or paper material employed in the reinforced absorbent article. This electrostatic adhesion usually occurs prior to the heat-sealing phase, thus the need for adhesive is eliminated.

The layers of the reinforced absorbent article of the present invention may be corona treated. Corona treatment of film, non-woven, and coated or treated paper surfaces is generally used to promote improved ink anchorage in printing. It has been found that corona treatment of the inside surfaces of film, non-woven, and paper layers in absorbent articles without adhesives may improve adhesion during the heat sealing stage.

The following examples further demonstrate the present invention. It should be understood that these examples are merely illustrative and are not meant to limit the scope of the present invention in any way.

### EXAMPLE 1

Referring to FIGS. 3 and 4, in one embodiment according to the present invention, reinforced absorbent article 20 is a reinforced absorbent food pad. The reinforced absorbent food pad has an absorbent core 22 and has two food-grade plastic reinforcement strips 24, 25 disposed between top layers 26 and bottom layers 28. Top layers 26 and bottom layers 28 are sealed around periphery 30.

The food-grade plastic reinforcement strips 24, 25 run about 100% of the length L of the absorbent food pad and are each located at a distance X, which is about 20% of width Z. The food-grade plastic reinforcement strips 24, 25 have a width between about 0.06 inches to about 0.09 inches and a thickness between about 0.01 inches to about 0.03 inches. The reinforcement strips 24, 25 may or may not be held in place with adhesive.

### EXAMPLE 2

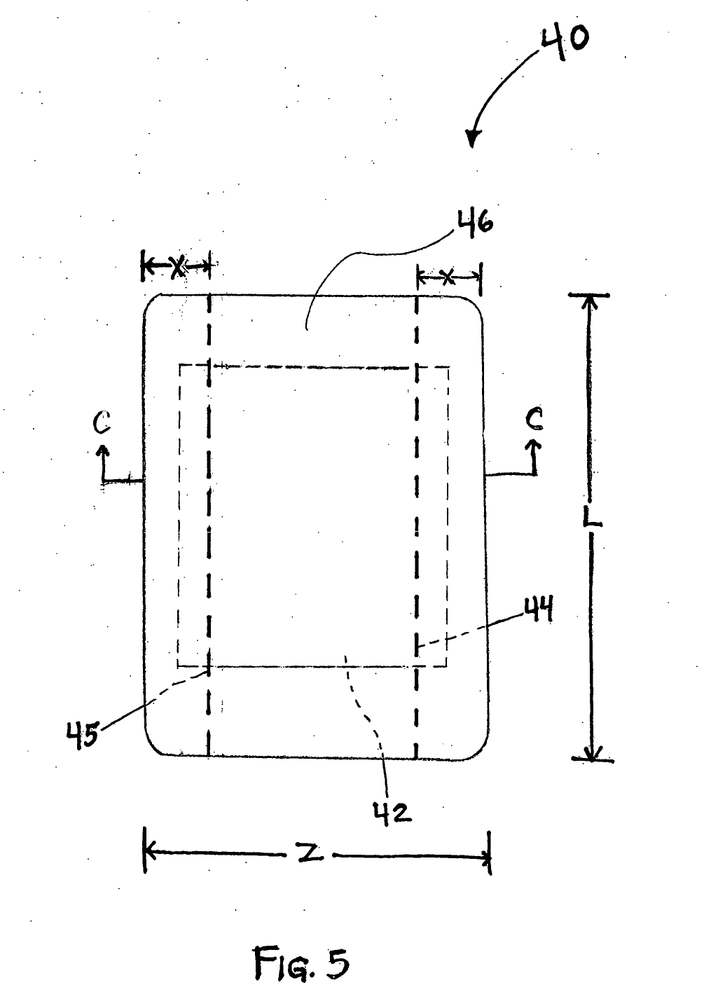

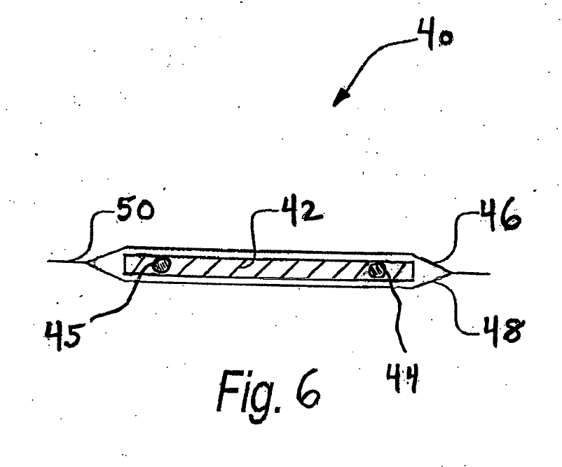

Referring to FIGS. 5 and 6, in another embodiment according to the present invention, reinforced absorbent article 40 is a reinforced absorbent food pad. The reinforced absorbent food pad has an absorbent core 42 and has two food-grade plastic reinforcement strips 44, 45 disposed between top layers 26 and bottom layers 28. The reinforcement strips 44, 45 are positioned through absorbent core 42. Top layers 46 and bottom layers 48 are sealed around periphery 50.

The food-grade plastic reinforcement strips 44, 45 run about 100% of the length L of the absorbent food pad and are located at a distance X, which is about 20% of width Z. The food-grade plastic reinforcement strips 44, 45 have a width between about 0.06 inches to about 0.09 inches and a thickness between about 0.01 inches to about 0.03 inches. The reinforcement strips 44, 45 may or may not be held in place with adhesive. If adhesive is used, reinforcement strips 44, 45 may be coated in any suitable adhesive prior to or during placement in the reinforced absorbent pad 40.

The reinforced absorbent articles of the present invention may be constructed by any method appropriate to result in the desired unique features described above. In general, raw materials are brought to the processing line in rolls. The materials are converted into the reinforced absorbent articles of the present invention. Finished reinforced absorbent articles may be processed in one or more of several ways including: cut into individual pieces and packaged in bulk, connected together with perforations and wound onto a roll or spool for downstream processing, connected together with perforations and placed into a bin or carton for downstream processing, or placed into a tube or magazine for later insertion into a high-speed placement device.

Additional combinations and methods of manufacture are possible as provided in co-pending patent application bearing application Ser. No. 10/802,254, which describes shaped absorbent pads, and co-pending patent application bearing application Ser. No. 11/335,373, which describes food preservation systems. The entire disclosure of both co-pending applications is incorporated by reference herein.

The present invention has been described with particular reference to the preferred embodiments. It will be obvious to one of ordinary skill in the art that changes and modifications may be made to the above description without departing from the spirit and scope of the invention.

Wherefore we claim:

1. A reinforced absorbent article comprising:
one or more top sheets;
one or more bottom sheets;
an absorbent core disposed between said one or more top sheets and said one or more bottom sheets; and
one or more reinforcement means.

2. The reinforced absorbent article of claim 1, wherein said one or more reinforcement means is disposed between said one or more top sheets and said one or more bottom sheets.

3. The reinforced absorbent article of claim 1, wherein said one or more reinforcement means comprises material selected from the group consisting of plastic, rubber, wood, metal, fiberglass, composites, paper, compressed paper, paper board, fiber board, cork, and any combinations thereof.

4. The reinforced absorbent article of claim 1, wherein said one or more reinforcement means has a structure selected from the group consisting of one or more strips, ribs, rods, ribbons, and any combinations thereof.

5. The reinforced absorbent article of claim 1, wherein said one or more reinforcement means has a length between about 10% to about 100% of a total length of said absorbent article.

6. The reinforced absorbent article of claim 1, wherein said one or more reinforcement means is disposed in or on said reinforced absorbent article at a distance from a longitudinal edge equal to between about 5% to about 35% of a total width of said reinforced absorbent article.

7. The reinforced absorbent article of claim 1, wherein said one or more reinforcement means has a width of about 0.005 inches to about 0.5 inches.

8. The reinforced absorbent article of claim 1, wherein said one or more reinforcement means has a thickness of about 0.001 inches to about 0.1 inches.

9. The reinforced absorbent article of claim 1, wherein said one or more reinforcement means are secured to at least one of said one or more top sheets, one or more bottom sheets, and absorbent core.

10. The reinforced absorbent article of claim 9, wherein said one or more reinforcement means are secured by an adhesion means selected from the group consisting of adhesive, heat sealing, static charge, and any combinations thereof.

11. The reinforced absorbent article of claim 1, wherein said reinforced absorbent article is a reinforced absorbent food pad or a reinforced absorbent medical pad.

12. A reinforced absorbent food pad comprising one or more reinforcement means.

13. The reinforced absorbent food pad of claim 12, further comprising one or more top sheets, one or more bottom sheets, and an absorbent core disposed between said one or more top sheets and said one or more bottom sheets.

14. The reinforced absorbent food pad of claim 13, wherein said one or more reinforcement means is disposed between said one or more top sheets and said one or more bottom sheets.

15. The reinforced absorbent food pad of claim 12, wherein said one or more reinforcement means comprises material selected from the group consisting of plastic, rubber, wood, metal, fiberglass, composites, paper, compressed paper, paper board, fiber board, cork, and any combinations thereof.

16. The reinforced absorbent food pad of claim 12, wherein said one or more reinforcement means has a structure selected from the group consisting of one or more strips, ribs, rods, ribbons, and any combinations thereof.

17. The reinforced absorbent food pad of claim 12, wherein said one or more reinforcement means has a length between about 10% to about 100% of a total length of said absorbent food pad.

18. The reinforced absorbent food pad of claim 12, wherein said one or more reinforcement means is disposed in or on said reinforced absorbent food pad at a distance from a longitudinal edge equal to between about 5% to about 35% of a total width of said reinforced absorbent food pad.

19. The reinforced absorbent food pad of claim 12, wherein said one or more reinforcement means has a width of about 0.005 inches to about 0.5 inches.

20. The reinforced absorbent food pad of claim 12, wherein said one or more reinforcement means has a thickness of about 0.001 inches to about 0.1 inches.

21. The reinforced absorbent food pad of claim 13, wherein said one or more reinforcement means are secured to at least one of said one or more top sheets, one or more bottom sheets, and absorbent core.

22. The reinforced absorbent food pad of claim 21, wherein said one or more reinforcement means are secured by an adhesion means selected from the group consisting of adhesive, heat sealing, static charge, and any combinations thereof.
